(19) United States
(12) Patent Application Publication
(10) Pub. No.: US 2007/0257527 A1
(43) Pub. Date: Nov. 8, 2007

(54) Cycle seat construction

(76) Inventor: Michel Marc, Lenexa, KS (US)

Correspondence Address: Barry R. Blaker, 4 Algonquin Road, Acton, MA, 01720, US

(21) Appl. No.: 11/415,809

(22) Filed: May 2, 2006

(51) Int. Cl. B62J 1/00

(52) U.S. Cl. 297/215.1

(57) ABSTRACT

Disclosed herein is a cycle seat construction whereby rotational and tipping motion of the pelvic girdle relative to the spine of the rider is vastly reduced or eliminated. The construction includes a longitudinally split seat support whose left and right halves are each pivotally mounted to a seat post such that the seat support halves independently pivot forwardly and rearwardly. The pivot points of the seat support halves are located substantially co-extensively with respect to the hip joints of the seated rider.

### BACKGROUND OF THE INVENTION

The present invention relates broadly to cycle seats and is more particularly directed towards a cycle seat construction which is responsive to the leg movements of the rider.

In pedal operated devices such as bicycles, tricycles, velocipedes, exercise bicycles, generators and the like the conventional seat is usually defined by a single static platform which supports the buttocks of the rider. In pedaling of the device, however, it is in the nature of things that the seated rider's pelvic girdle repetitively tips laterally from side to side and, in addition, rotates cyclically about the spinal axis. These repetitive motions can lead to discomfort and pain and, in some cases, to acute or chronic orthopedic and/or neurological conditions of the back and hips such as sciatica, compressed, ruptured or dislocated intervertebral disks or undue wear or erosion of the cartilage of the hip joints. Additionally, it is in the nature of things that the inner thighs of the rider rub repetitively over the seat, often leading to painful chafing of these areas of the anatomy.

It is known to provide a cycle seat construction in which the seat is longitudinally split into two discrete halves, said halves being pivotally mounted to the seat post. Such seat constructions are disclosed, for instance, in U.S. Pat. No. 531,333, to Rogers; U.S. Pat. No. 572,062, to Peck; U.S. Pat. No. 603,943, to Clifford; U.S. Pat. No. 604,347, to Bray; U.S. Pat. No. 694,875, to Meighan; U.S. Pat. No. 4,089,559, to Prange et al.; and U.S. Pat. No. 5,988,740, to Carabello. In these disclosed constructions, upon the downward stroke of the rider's leg, the seat half supporting that leg pivots or tilts downwardly and, upon the recovery stroke of the leg, pivots or tilts upwardly. Insofar as is known to the present applicant the geometric centers of the pivoting motions in such prior art seat all lie below the seat element. Thus, such seat constructions of the prior art do accommodate the motions of the rider's upper legs and do, at least to some extent, tend to provide an increase in comfort over the conventional static, one-piece seat constructions and at least some relief from the chafing problem outlined above. However, these known prior art split seat constructions neither address nor resolve the previously mentioned anatomical problem of lateral rocking and rotation of the pelvic girdle and the physical problems which flow from such motions. In accordance with the present invention, however, these problems have been substantially ameliorated.

It is a principal object of the present invention to provide a novel cycle seat construction.

It is another object of the invention to provide a cycle seat construction providing improved comfort to the rider.

It is still another object of the invention to provide a cycle seat construction which substantially and beneficially reduces side to side rocking of the rider's pelvic girdle and/or rotation of the pelvic girdle about the spinal axis.

Other objects and advantages of the present invention will, in part, be obvious and will, in part, appear hereinafter.

### BRIEF SUMMARY OF THE INVENTION

In accordance with the invention the cycle seat construction hereof comprises a seat element split longitudinally into two seat half portions. Said seat half portions are pivotally affixed in adjacent relationship to a seat post. Said pivotal affixation is conformed such that each seat half portion is enabled to tip forwardly and rearwardly and arcuately under the influence of the rider's leg supported thereby and independently of the other seat half portion and, further, the geometric center of said arcuate movement of said seat half portion being located substantially co-extensively with respect to the seated rider's hip joint.

### THE DRAWINGS

FIG. 1 is a diagrammatic, schematic plan view of one embodiment of a cycle seat construction in accordance with the invention.

FIG. 2 is a diagrammatic, schematic, partially sectional right side view of the embodiment of the invention shown in FIG. 1.

FIG. 3 is a diagrammatic, schematic, sectional front view of a portion of the embodiment of the invention shown in FIG. 2, taken through line 2-2′ thereof, and showing the right hand seat portion of the seat construction pivotally journalled to a seat post cap forming the upper end of the seat post.

FIG. 4 is a diagrammatic, schematic, partially phantom, side view of another embodiment of the cycle seat construction of the invention.

FIG. 5 is a diagrammatic, schematic, sectional front view of a portion of the embodiment of the cycle seat construction shown in FIG. 4, taken through line 4-4′ thereof, and showing the left hand seat portion of the seat construction pivotally journalled to the seat post.

### DETAILED DESCRIPTION OF THE INVENTION

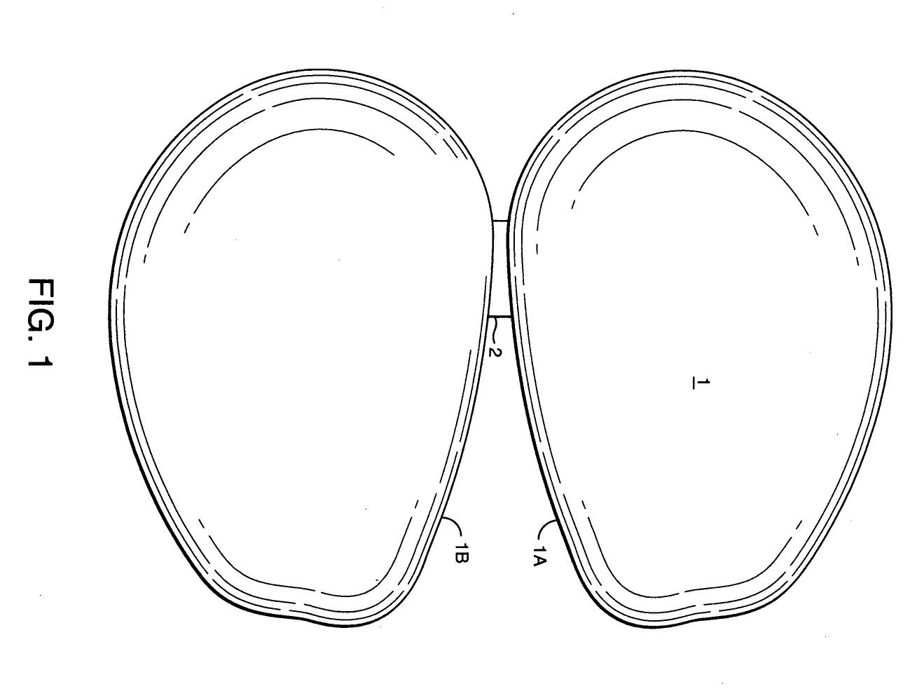

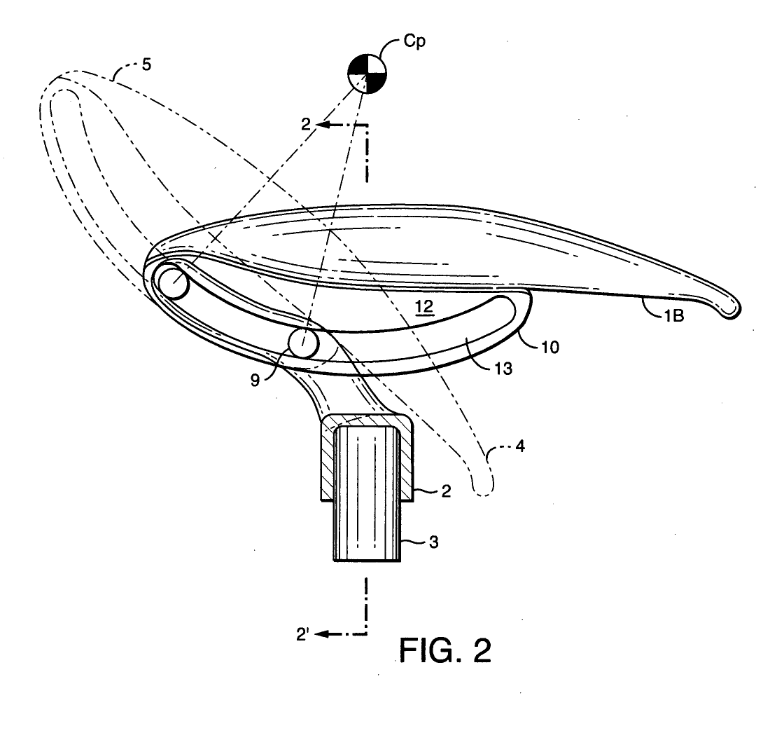

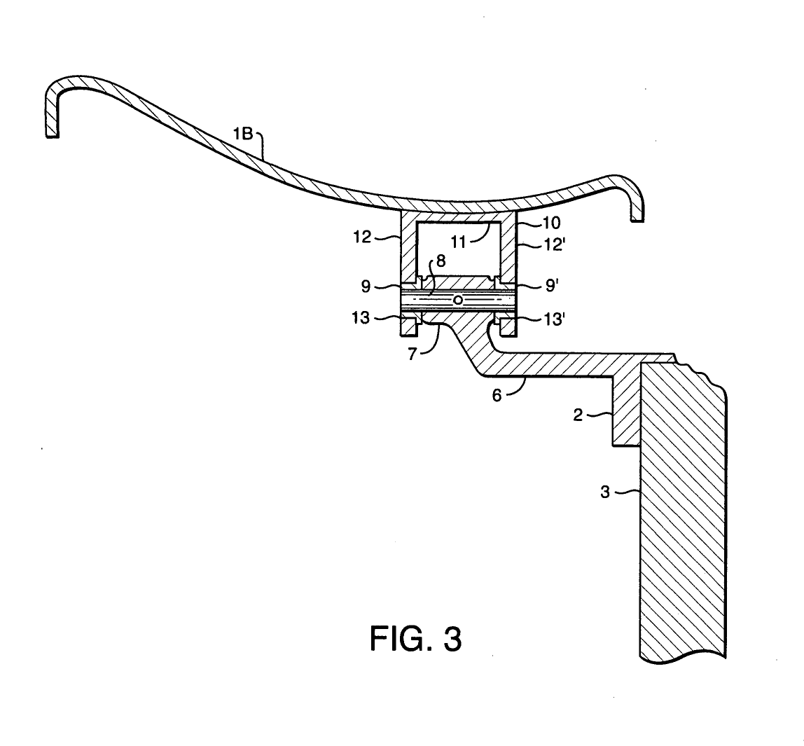

Referring now to FIGS. 1 through 3, wherein like reference numerals refer to like structures, the seat construction of the invention broadly comprises a seat element 1 composed of longitudinally separated seat half portions 1A and 1B which, in shape, are mirror images of one another. In this embodiment of the invention, and as is best seen in FIGS. 2 and 3, said seat half portions 1A and 1B are journalled in side by side relationship to a seat post cap 2 which, in turn, is fixedly secured to a seat post 3. Thus, as is shown in phantom in FIG. 2, when the seated rider thrusts the right hand pedal of the cycle device downwardly, the seat half portion 1B pivots under the influence of the leg thrust, thereby depressing the nose end 4 and raising the rear end 5 of said seat half portion 1B.

In accordance with the invention it is vital that the geometric pivot center C_{P} of the seat half portions 1A and 1B be spaced above the surface of the seat 1 and be located substantially co-extensively with the hip joint of the seated rider. In the embodiment of the invention of FIGS. 1-3 this necessary journalling of the seat 1 to the seat post 3 is accomplished as follows, it being understood that, while only the right hand seat half portion 1B is shown and will be discussed in detail, the mirror image left hand seat portion 1A is similarly journalled. The seat post cap 2, which as mentioned is affixed to the top end of the seat post 2 and thus forms an integral part thereof comprises a lateral wing 6 which bends upwardly at its terminus, said terminus being defined by a lateral boss 7. Projecting from both ends of said boss 7 is a shaft 8 which receives cam rollers 9 and 9′ on the exposed ends thereof. Secured to the bottom of the seat half portion 1B is a cam element 10 formed of an inverted channel stock. Thus, the bottom wall 11 of said cam element 10 is secured to the bottom of the seat half portion 1B while the side walls 12, 12′ depend therefrom. Cut through said side walls 12, 12′ are co-extensive arcuate slots 13, 13′ which define the cam profile and which receive the cam rollers 9 and 9′ to complete the pivoting construction of the embodiment shown in FIGS. 1-3. As will be noted the arc defined by the slots 13, 13′ has a geometric center or pivot center C_{P} which is spaced above the seat 1 and is located substantially co-extensively with respect to the hip joint of the seated rider. Thus, it will readily be appreciated that the locating of the geometric center or pivot center for the seat 1 will be dictated by the selection of the radius of the arcuate slots 13, 13′, the distance said slots depend below the bottom of the seat 1 and the front to back positioning of said slots relative to the seat half portion 1B. Thus, these parameters may be readily taken into account and selected for any particular seat geometry in order to locate the pivot center of the seat substantially co-extensively with respect to the hip joint of the seated rider. Too, it is obvious that the front and rear ends of the slots 13, 13′ define stops for the downward and upward pivoting of the seat half portion 1B. Therefore, the locations of the front and rear ends of said slots 13, 13′ on the cam element 10 should also be duly considered.

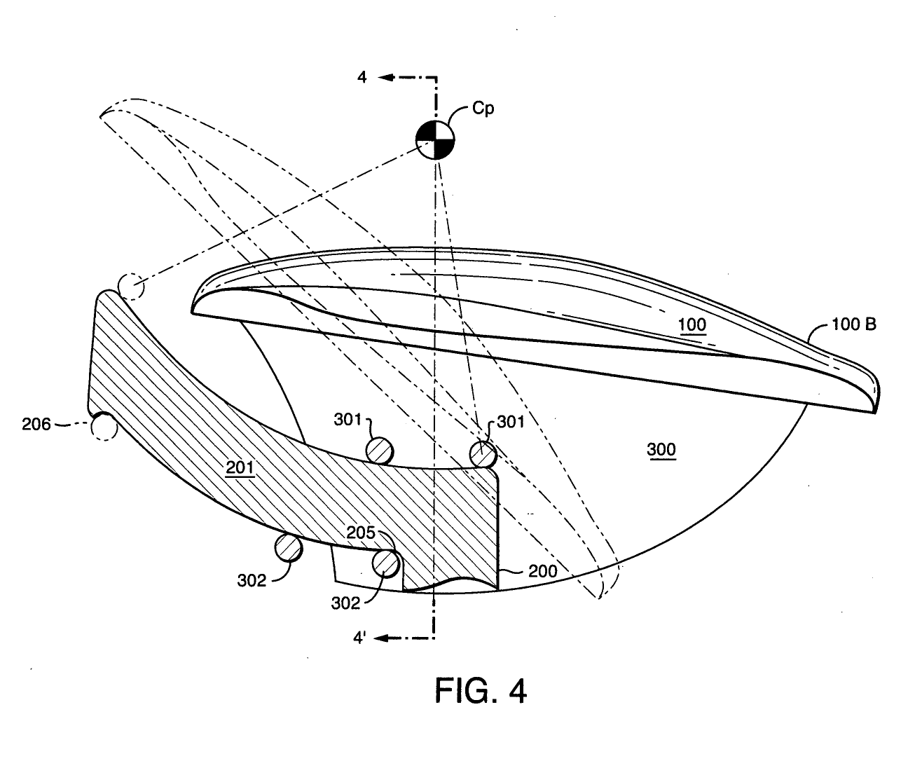

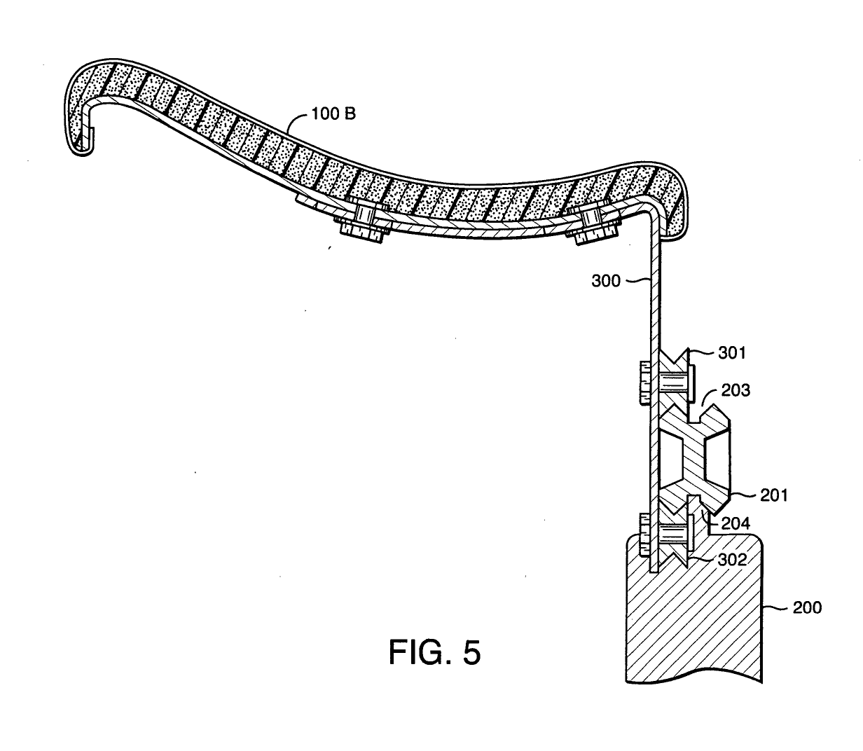

Another embodiment of the cycle seat construction of the invention is presented in FIGS. 4 and 5 hereof. As in the case of the embodiment shown in FIGS. 1-3, FIGS. 4 and 5 depict only the right hand side of the construction, it being understood that the left hand side thereof is a mirror image of said right hand side. Referring to said FIGS. 4 and 5 there is broadly shown a cycle seat 100 pivotally mounted on a seat post 200. The top of the seat post 200 comprises a trailing arcuate rail 201 which, in cross section, comprises top and bottom flat bottomed V-grooves 203 and 204. Said rail 201 thus defines an arcuate cam whose geometric center or pivot center C_{P} is spaced above the seat 100 and is located substantially co-extensively with respect to the hip joints of the seated rider. Secured to the bottom of the seat half portion 100B is a depending plate 300 to which there is journalled a pair of top cam rollers or followers 301 and at least one bottom cam roller or follower 302. Said cam followers 301, 302 each have cross sections adapted to engage the right hand sides of the V-grooved rail 201 and are spaced so as to securely capture said rail 201 therebetween. Thus, as is shown in phantom in FIG. 4, when the seated rider thrusts the right hand cycle pedal downwardly, the front end of seat half portion 100B pivots downwardly under the influence of the rider's upper leg thrust while the rear end thereof pivots upwardly. Of course, when the left leg thrusts downwardly the right hand pedal is forced upwardly, thereby raising the right leg and causing the front end of seat half portion 100B to pivot upwardly and the rear end thereof to pivot downwardly. The bottom of the rail 201 is provided with spaced apart front and back steps 205 and 206, respectively. Said steps engage the bottom cam followers 302 at the limits of their travel, thereby serving as front and back stops for the pivotable seat half portion 1B.

By virtue of the construction of the invention it has been found that the deleterious side to side tipping and rotation of the pelvic girdle about the spinal axis experienced with cycle seats of the prior art, and particularly those of fixed, one-piece construction, is eliminated or, at the least, substantially reduced.

The materials of construction and fabrication techniques utilized in the realization of the cycle seat construction of the present invention are generally conventional in the art and require no extensive elaboration herein. In general, metals and metal alloys based upon aluminum, titanium, iron and structural plastics, such as glass fiber reinforced nylon, para-aramids, carbon/epoxy and boron/epoxy composites can find substantial utility in the fabrication of the structural elements of the invention. Also, fabrication techniques such as milling, casting, machining, water jet cutting, molding and the like are all contemplated as being useful in the fabrication of the invention.

Many obvious modifications, substitutions, additions and the like may be made to the preferred embodiments of the invention described above without departing the essential scope and spirit of the invention. For instance, while not previously mentioned, The cycle seat construction of the invention may also include return means, such as suitably conformed coil or leaf springs, by which the seat half portions are returned to a common resting position upon dismounting of the rider therefrom. Additionally, it is contemplated that the principles of the seat construction of the invention can also be beneficially applied to static seating as well as cycle seats. For instance, in the present static airline passenger seating it is known that failure to exercise the legs over the duration of a long flight, such as by periodically standing up and walking up and down the aircraft's aisles, can lead to dangerous pooling of the blood and lymph in the lower extremities and foster the formation of blood clots. Use of the present invention in such seating can afford the seated passenger with the opportunity to exercise his or her legs while remaining seated, thereby reducing such pooling without the bothersome necessity of disturbing neighboring seated passengers and/or occluding the generally narrow aisles of the aircraft. Thus, embodiments and modifications other than the presently preferred embodiments described above may be made without departing from the scope of the invention as defined in the claims that follow.

What is claimed is:

1. A cycle seat construction for pedal powered: devices comprising:
(A) left and right seat half portions, together defining a seat support for a rider;
(B) a seat post adapted to be rigidly affixed to said device;
(C) each said seat half portion of (A) being pivotally affixed to said seat post of (B) such that each said seat half portion moves: (I) independently of the other seat portion; (ii) arcuately under the influence of the rider's leg supported thereon; and (iii) around a pivot center which is substantially co-extensive with the hip joint of the seated rider.

2. The cycle seat of claim 1 wherein said pivotal affixation of said left and right seat portions to said seat post comprises:
(A) a seat post cap secured to said seat post, said seat post cap having left and right lateral wings extending therefrom, each said wing having a terminus which is upwardly bent and comprises a lateral boss extending from the sides thereof;
(B) a shaft extending through the lateral boss of each said terminus and having free ends projecting from each side thereof;
(C) a cam roller journalled to each free end of each said shaft;
(D) said left and right seat portions each having a cam element secured to the bottom thereof, said cam element comprising an inverted channel having spaced apart depending side walls corresponding to the pair of said cam rollers of the lateral wing corresponding thereto, said spaced apart depending side walls having co-extensive arcuate slots, said slots being adapted to receive said cam rollers therethrough.

3. The cycle seat of claim 1 wherein said pivotal affixation of said left and right seat portions to said seat post comprises:
(A) said seat post having a top to which there is affixed a trailing upwardly arcuate rail extending rearwardly therefrom, said rail, in cross section, having top and bottom flat bottomed V-grooves;
(B) said left and right seat half portions each having a depending plate secured to the bottom thereof and to which depending plate there are journalled spaced apart top and bottom cam rollers, the cross sections of said rollers being adapted to engage the side of the v-groove rail in correspondence therewith and the spacing between said top and bottom cam rollers being adapted to securely capture said rail therebetween.
